(19) United States
(12) Patent Application Publication
(10) Pub. No.: US 2003/0106722 A1
(43) Pub. Date: Jun. 12, 2003

(54) Weighline collector

(76) Inventor: James H. Brown, Kingston (CA)

Correspondence Address: DOWELL & DOWELL, PC, Ralph A. Dowell, Suite 309, 1215 Jefferson Davis Hwy, Arlington, VA, 22202, US

(21) Appl. No.: 10/006,393

(22) Filed: Dec. 10, 2001

(51) Int. Cl. G01G 13/22

(52) U.S. Cl. 177/59; 177/83; 177/54; 222/77; 141/83

(57) ABSTRACT

An apparatus for precisely weighing and bagging solid particulate materials in which a carousel is mounted on a vertical axis intermediate a material dispenser and a weighing device such as a load cell. A series of sheet metal material collectors, pivotally mounted on the carousel to receive material dispensed thereto, are indexed around to a series of dispensers and then to a bagging station where they are tilted to discharge material thereon.

### FIELD OF INVENTION

This invention relates to weighing equipment and more particularly to equipment for very accurately weighing relatively small quantities of solid particulate materials.

### BACKGROUND OF INVENTION AND PRIOR ART

While this invention will be described with particular reference to weighing materials for use in the manufacture of rubber tires, it will be appreciated that the principles thereof may also be used in any situation where precise quantities of specified solid particulate materials are to be produced in a more or less automated system.

In the manufacture of rubber tires, the basic natural and/or synthetic rubber material is blended thoroughly with precisely measured quantities of specific chemical additives to form rubber tire materials of the desired properties. The blended materials are subsequently formed into tires. To facilitate both measurement and handling, the chemicals are generally weighed and assembled separately and packaged in lightweight plastic bags. The bag contents conform to the requirements of the particular rubber product being produced so that they can be added to the blender in a single operation. The bags are absorbed into the rubber product so their mass and labelling must be consistent with the blended product.

In this specification, the following terms will be defined as follows:

Chemicals are solid particulate materials of specific compositions and in physical forms that are consistent with precise quantity measurements. They preferably have the following properties:

free-flowing and not agglomerated to an extent that would prevent precise weighing;

particle sizes must be small enough to allow precise weighing and handling;

substantially dust-free so as to minimize human health hazards.

Packages of chemicals are quantities of precisely weighed chemicals in plastic bags. The weights of individual chemicals and the total weight of the package is specified by the tire manufacturer and checked before delivery. Each package is marked with the identification desired by the tire manufacturer. Package weights may range from a pound or so to over 20 pounds.

A Weighment is a precisely weighed amount of a chemical to be included in a package. In current practice a package may include up to 8 weighments, commonly it includes fewer than 6. The tire manufacturer may specify the accuracy of weighments as +/−0.01 pounds and the weight of the package to be +/−0.01 pounds times the number of weighments in the package.

A Menu for a package specifies all of the chemicals to be included in the package and the weight of each weighment.

A Batch of packages consists of all packages of a specific menu to be produced and delivered as a unit, commonly a batch includes about 50 to 150 packages

Common current practice for preparing chemical packages involves two general aspects:

1) Weigh stations that include chemical feeders, scales, and control systems that deliver weighments for packaging;

2) Means for collecting weighments in bags.

Commonly, the requisite number of weigh stations are set over a conveyor that provides indexed movement of bags mounted in plastic pails below the weigh stations to receive weighments as they are produced. When a bag has received its full complement of weighments, it is weighed, sealed, marked and routed for shipment with its batch. Individual weigh stations are often devised as interchangeable modular units that can be set up to suit specified menus and the assembly of weigh stations is referred to as a weigh line. The weigh line may include a conveyor belt as the device moving the bags, roller conveyors may be used, and undoubtedly other systems could also be adopted.

Also, in current practice, bags are usually mounted manually in a plastic pail or container to facilitate movement of the bags along the weigh line although automatic means exist for mounting bags in pails, boxes and other containers automatically. However, if the bags are too light to allow reliable automatic mounting, if the value of the materials being packaged is too high to allow losses due to bag failures, or if the hazards associated with bag or bagging failures are too high, the bag-in-pail approach may be unavoidable in these weigh line systems.

Given the low weight of the plastic carrier pails and the high precision that can be obtained with contemporary load cells, it is practical to measure weighments directly into the mounted bag, effectively making the pail and bag part of the weighing system.

Equipment exists to form bags directly from sheets of plastic, and to fill and seal those bags while they are still in the forming machine. Moreover, a final weighing could also be incorporated into the device along with a marker. Thus, a fully automated form-fill-seal-weigh-mark machine can be assumed. For present purposes, such a machine is referred to as a bagging machine.

The net effect of the above conditions is that most contemporary packaging systems require manual bag mounting and handling with the attendant labour costs. Moreover, these jobs are tedious, and often undesirable, assignments the elimination of which would improve the employment, health and safety atmosphere of the chemical packaging facility.

### OBJECT OF INVENTION

Thus, there is a need to provide equipment which eliminates the need for mounting bags in pails or other devices, to eliminate the jobs and hazards associated with manually handling bags and packages in the packaging plant, and to allow automation of the entire packaging operation.

### BRIEF STATEMENT OF INVENTION

Thus, by one aspect of this invention there is provided in an apparatus for weighing and bagging solid particulate materials comprising material storage means, material discharge means operatively associated with a weighing means, and bagging means; the improvement comprising:

(a) carousel means mounted for rotation about a vertical axis, intermediate said discharge means and said weighing means;

(b) collector means supported by first support means on said carousel means and including second support means extending through said carousel means for operative engagement with said weighing means; and

(c) means for tilting said collector means from a receiving position adjacent said discharge means to a discharge position adjacent said bagging means.

### BRIEF DESCRIPTION OF DRAWINGS

FIG. 1 is a plan view of a weigh platform according to one embodiment of the present invention;

FIG. 2 is a side view of a carousel according to one embodiment of the present invention;

FIG. 3 is plan view of a collector plate according to one embodiment of the present invention;

FIG. 4 is an end view of the collector of FIG. 3 taken along line 4-4;

FIG. 5 is an end view of the collector of FIG. 3 taken along line 5-5; and

FIG. 6 is an isometric view of the collector of FIG. 3.

### DETAILED DESCRIPTION OF PREFERRED EMBODIMENT

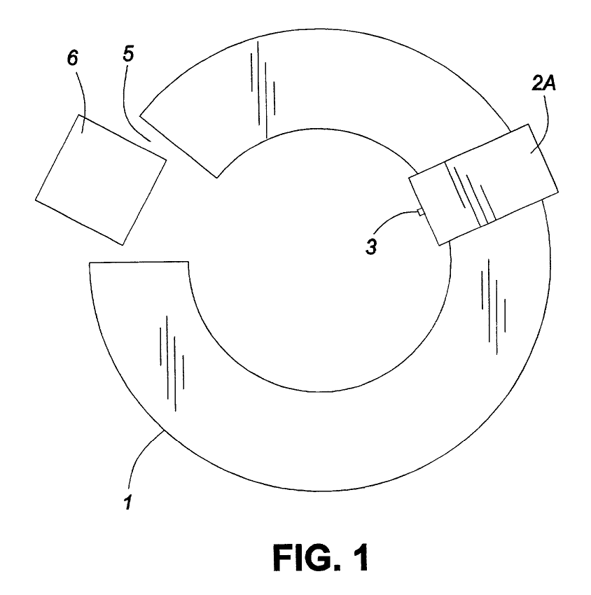

FIG. 1 shows a hollow circular weigh line platform 1 which provides 10 sectors of 36 degrees each, although it will be appreciated that the number of sectors and associated equipment is entirely arbitrary, depending upon specific operational requirements. Solid particulate material feed hoppers 2, each provided with a discharge 3, comprising any conventional discharge mechanism, such as one or more screw augers or vibrating feeders, are mounted on platform 1, and operatively connected to a weighing device 4, such as a load cell mounted vertically below each discharge 3 and spaced therefrom. For clarity, only one feed hopper is shown in FIG. 1, as represented by the footprint 2a thereof, but it will be appreciated that a feed hopper and associated weighing equipment may be provided at each sector. The outer diameter of platform 1 is, preferably but not essentially, about eighteen feet and the inner diameter is, preferably but not essentially, about fourteen feet, and the weigh station hoppers 2 are preferably located so that the discharges 3 therefrom are located adjacent the inner diameter of the platform 1. The platform 1 preferably does not extend through the sector 5 under which a bagging machine 6 is located, represented schematically by the footprint thereof, so as to provide clear head space for the tilting mechanism described hereinbelow.

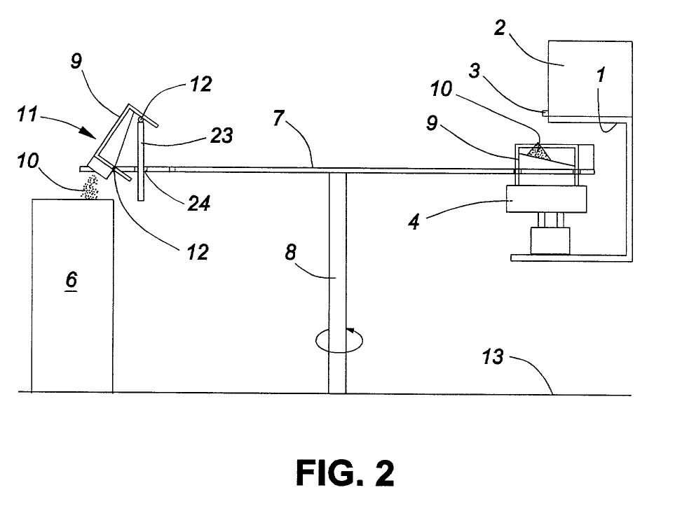

Intermediate between the platform 1 and the weighing device 4, there is provided a rotatable carousel 7, mounted on a vertical axis 8 and concentric with platform 1, as seen in FIG. 2.

To receive weighments in accord with menu requirements, ten collectors 9 are mounted on carousel 7 that moves or indexes the collectors 9 below each of the weigh stations 2, in turn, as shown in FIG. 2. The position of the bagging machine 6 below the collectors at the discharge position 5 is merely a matter of convenience. It would be practical to incorporate means for lifting collectors up at that point and causing them to discharge into a bagging machine that is some distance from or even above the carousel 7.

In operation, the weighment 10 from the weigh station would be deposited on the collector 9 when the collector is in its receiving position beneath a respective discharge 3. When the collector reaches the bagging machine station 6, it is tilted to a discharge position as indicated 11 by pivoting the collector 9 about a pivot point 12 by means of any convenient tilting mechanism. Such mechanism may be effected in any one of several known ways. For example, an arm (not shown) suspended above the bagging machine 6 and carousel 7 may be lowered into releasable engagement with the inner end of collector 9 and then raised so as to lift the inner end of the collector to the discharge position 11. After discharge the collector would be lowered to the horizontal position. Alternatively, a lifting arm or cam (not shown) may be incorporated into the carousel 7 to raise and lower the inner end of the collector 9. In a third alternative a push rod 23 may be provided through a slot 24 in the carousel to engage the inner end of the collector so as to raise and lower it as required. Any of these arrangements may include a vibrator (not shown) so as to ensure complete discharge of the material therefrom, and smooth flow of the weighments into the bagging machine 6. Movement of the collectors 9 is established through indexed rotation of the carousel 7. Also, as indicated, although the entire carousel 7 is shown mounted on the plant floor 13, other arrangements could also be used.

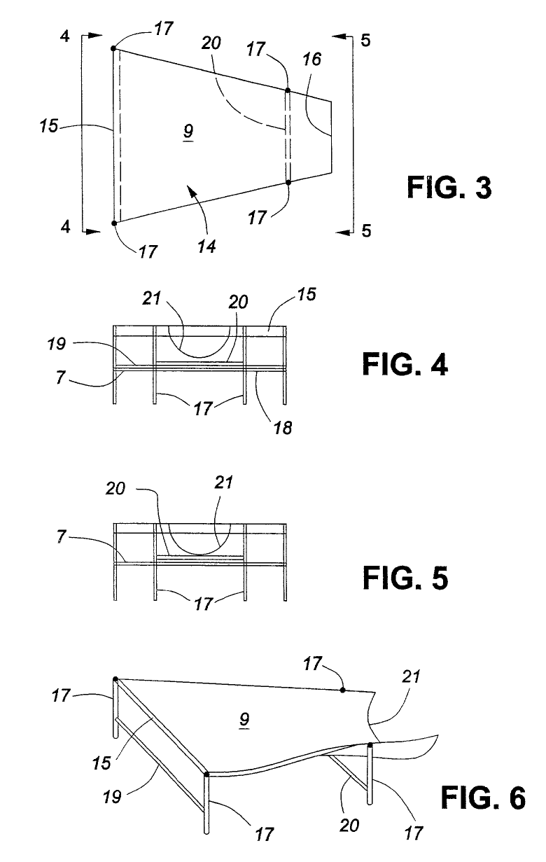

The construction of the collector 9 is illustrated in FIGS. 3-6 and comprises a sheet of polished metal 14, preferably about 30 inches long and tapered in width from about 24 inches at one end 15 to about 13 inches at the other end 16. This sheet preferably has a fold about 1 inch wide at its wide end 15 so as to provide rigidity, and the remainder of the sheet is formed into a gradual trough with a semicircular cross-section of about 9 inches diameter at the other end 16 so as to form a funnel 21. Legs 17 are attached to the sheet 14 and depend through loose holes 18 in carousel 7 for engagement by the weigh system 4 located beneath each sector. These leg structures which preferably consist of rods or tubes are bent to fit through the holes 18 in the carousel 7. Additional rods or tubes 19, 20 are attached between the legs17 at each end15, 16 of collector 9 respectively so as to support the collector 9 on carousel 7, to allow positioning of the collector 9 on the carousel 7 and to provide the hinge axis 12, toward but not at, the funnel 21 for tilting the collector 9 to discharge the accumulated weighments.

A brush arrangement (not shown) may be set over the tilted collector to be activated after the package weighments are discharged and before the collector is returned to its receiving position. Thus, reproducible cleanliness of the collectors can be assured without introducing a labour requirement. In addition, it will be clear that little effort would be involved in thoroughly cleaning all collectors in the system at the finish of a production run.

I claim:

1. In an apparatus for weighing and bagging solid particulate materials comprising material storage means, material discharge means operatively associated with a weighing means, and bagging means; the improvement comprising:
(a) carousel means mounted for rotation about a vertical axis, intermediate said discharge means and said weighing means;
(b) collector means supported by first support means on said carousel means and including second support means extending through said carousel means for operative engagement with said weighing means; and
(c) means for tilting said collector means from a receiving position adjacent said discharge means to a discharge position adjacent said bagging means.

2. An apparatus as claimed in claim 1, including a plurality of said material storage means, and a plurality of said material discharge means operatively associated with said weighing means.

3. An apparatus as claimed in claim 1, wherein said collector means comprises a tapered metal sheet.

4. An apparatus as claimed in claim 3, wherein said tapered metal sheet has a semicircular cross section at a narrow end thereof.

5. An apparatus as claimed in claim 1, wherein said first support means comprise transverse members secured between respective pairs of said second support means.

6. An apparatus as claimed in claim 5, including pivot means mounted on said carousel means operatively associated with one of said transverse members.

7. An apparatus as claimed in claim 1, wherein said material storage means and said material discharge means are mounted on a circular platform above and concentric with said carousel.
